(19) United States
(12) Patent Application Publication
(10) Pub. No.: US 2025/0253588 A1
(43) Pub. Date: Aug. 7, 2025

(54) ELECTRICAL CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: JOU-TZU SHEN, New Taipei (TW); Wei-Ta Tseng, New Taipei (TW); Kuei-Chung Tsai, New Taipei (TW)

(21) Appl. No.: 19/035,102

(22) Filed: Jan. 23, 2025

(30) Foreign Application Priority Data
Feb. 2, 2024 (CN) 202410153693.1

(51) Int. Cl. H01R 13/6471; H01R 13/424

(52) U.S. Cl. CPC H01R 13/6471; H01R 13/424

(57) ABSTRACT

An electrical connector includes: an insulative housing; and a row of first terminals arranged on the insulative housing along a first direction and each including a retaining portion fixed to the insulative housing, a contacting portion and a tail portion extending from two ends of the retaining portion respectively, the row of first terminals including plural first differential-pair terminals and plural first grounding terminals, the first differential-pair terminals and the first grounding terminals alternately arranged with each other along the first direction, each first differential-pair terminals including a pair of first differential signal terminals, wherein the pair of first differential signal terminals of at least one of the plural first differential-pair terminals have overlapping portions overlapping each other in a second direction perpendicular to the first direction, and the contacting portion and the tail portion of each first differential signal terminals extend along a straight line.

### BACKGROUND OF THE INVENTION

### 1. Field of the Invention

The present invention relates to an electrical connector for high frequency transmission.

### 2. Description of Related Art

U.S. Pat. No. 10,320,102 discloses an electrical connector including an insulative housing and two rows of terminals arranged in the insulative housing. Each terminal includes a retaining portion fixed to the insulative housing, a contacting portion, and a tail portion extending from two opposite ends of the retaining portion. The terminals include a plurality of grounding terminals and signal terminals. When the terminals transmit high-frequency signals, signal crosstalk occurs between the signal terminals arranged in a same plane.

It is desired to provide an electrical connector with an overlapping portion to transmit high frequency signals.

### SUMMARY OF THE INVENTION

An electrical connector comprises: an insulative housing; and a row of first terminals arranged on the insulative housing along a first direction and each including a retaining portion fixed to the insulative housing, a contacting portion and a tail portion extending from two ends of the retaining portion respectively, the row of first terminals including a plurality of first differential-pair terminals and a plurality of first grounding terminals, the first differential-pair terminals and the first grounding terminals alternately arranged with each other along the first direction, each first differential-pair terminals including a pair of first differential signal terminals, wherein the pair of first differential signal terminals of at least one of the plurality of first differential-pair terminals have overlapping portions overlapping each other in a second direction perpendicular to the first direction, and the contacting portion and the tail portion of each first differential signal terminals extend along a straight line as viewed from the second direction.

Other advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector according to the invention;

FIG. 2 is another perspective view of the electrical connector of FIG. 1;

FIG. 3 is an exploded perspective view of the electrical connector of FIG. 1;

FIG. 4 is another exploded perspective view of the electrical connector of FIG. 3;

FIG. 5 is a perspective view of a first insulator, a second insulator and terminals assembled together;

FIG. 6 is another perspective view of a first insulator, a second insulator and terminals assembled together of FIG. 5;

FIG. 7 is a further exploded perspective view of FIG. 5;

FIG. 8 is another exploded perspective view of FIG. 7;

FIG. 9 is a cross-sectional view of the electrical connector of FIG. 1 along line A-A to show positional relationship between a first differential pair and a second differential pair;

FIG. 10 is a side view of terminals according to the invention;

FIG. 11 is a cross-sectional view of the electrical connector of FIG. 1 along line B-B to show positional relationship between overlapping portions;

FIG. 12 is a top view of first terminals and second terminals according to the invention; and

FIG. 13 is a rear view of terminals according to the invention.

### DETAILED DESCRIPTION OF THE PREFERRED EMBODIMENT

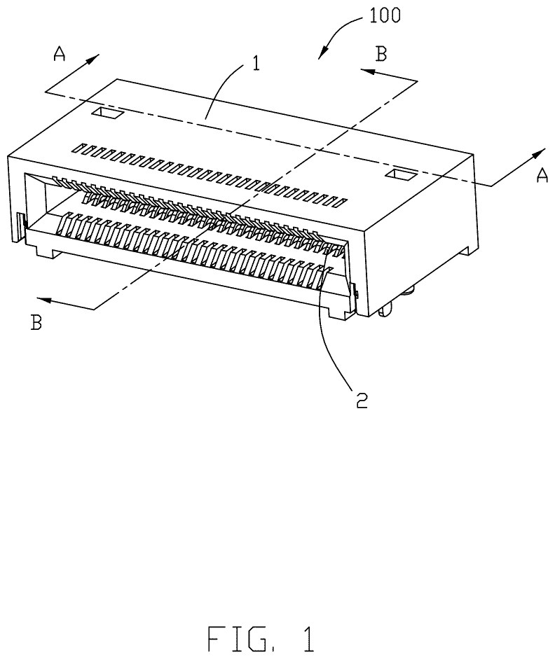

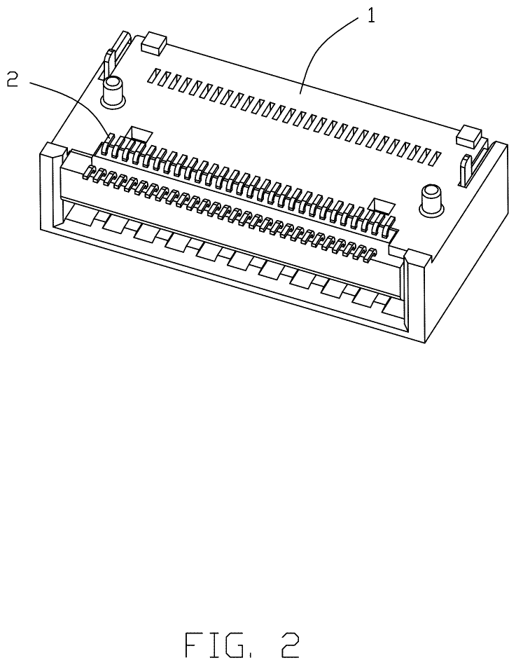

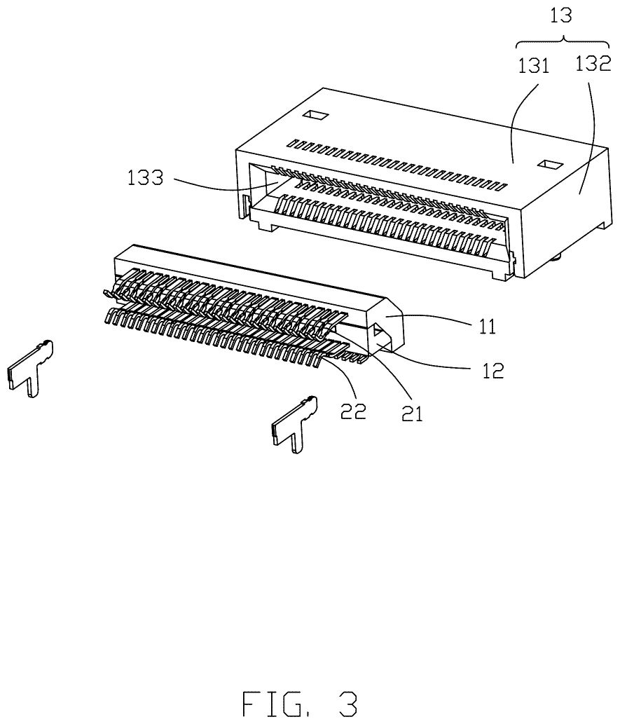

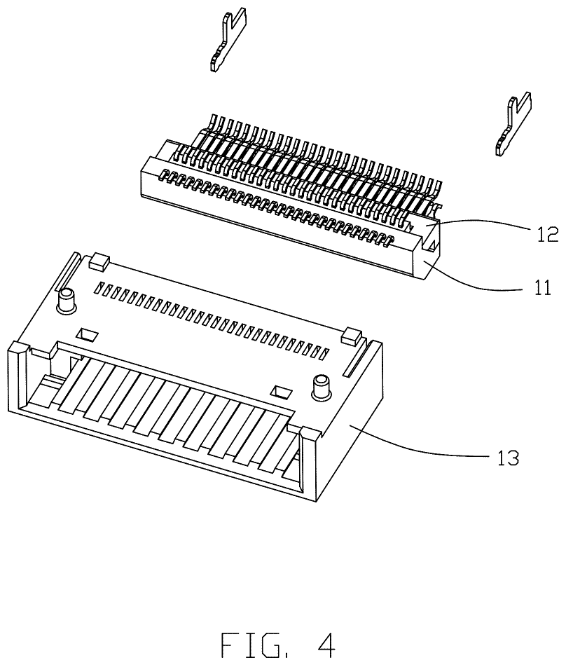

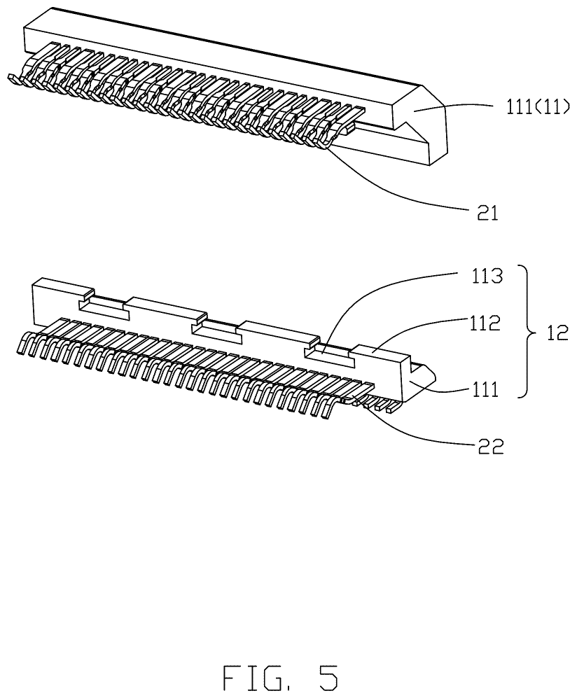

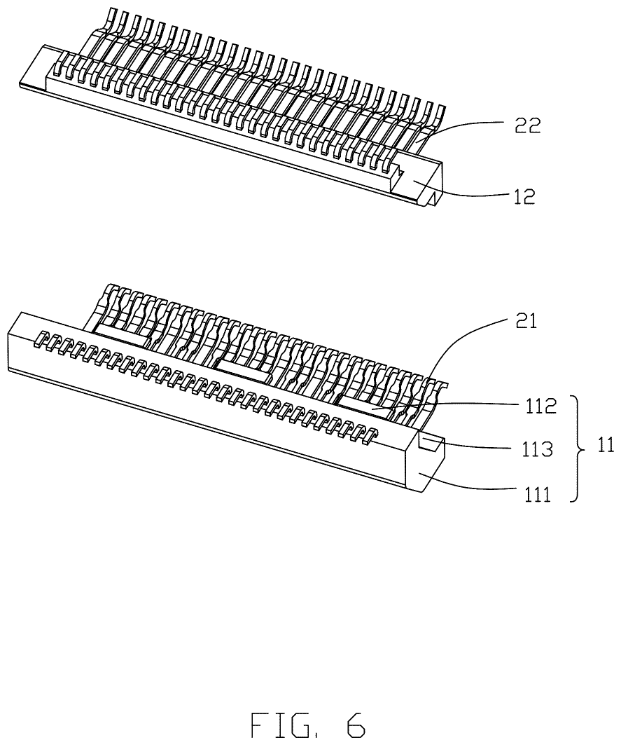

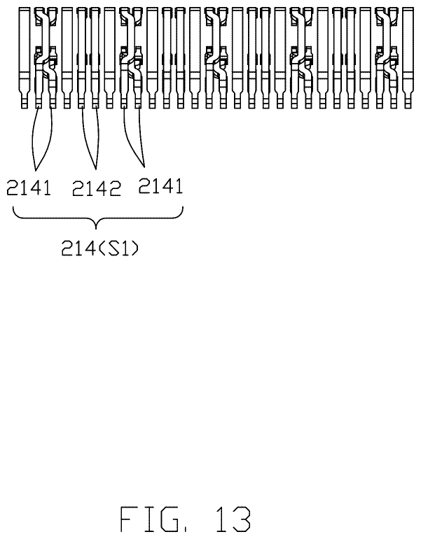

Referring to FIGS. 1-13, the present invention is an electrical connector 100 for high-speed signal transmission.

As shown in FIGS. 1-6, the electrical connector 100 includes an insulative housing 1 and two rows of terminals 2 fixed to the insulative housing 1. The insulative housing 1 includes a first insulator 11, a second insulator 12, and an insulative case 13 sleeved outside the first insulator 11 and the second insulator 12. The insulative case 13 includes a pair of side walls 131 extending along a first direction and a pair of end walls 132 extending in a second direction perpendicular to the first direction to connect the pair of side walls 131. The pair of side walls 131 and the pair of end walls 132 surround to form a mating groove 133 recessed from the front end of the insulative case 13. The first insulator 11 and the second insulator 12 have a base 111 for holding the terminals 2, a convex portion 112 formed by protruding inwardly from the inner surface of the base 111 along the second direction, and a concave portion 113 formed at interval between two adjacent convex portions 112 in the first direction. The first insulator 11 and the second insulator 12 are assembled together via the engagement of the convex portion 112 and the concave portion 113, and then assembled into the insulative case 13. The terminals 2 include a row of first terminals 21 fixed in the first insulator 11 and a row of second terminals 22 fixed in the second insulator 12. The first terminals 21 and the second terminals 22 are respectively located on opposite sides of the mating groove 133 in the second direction.

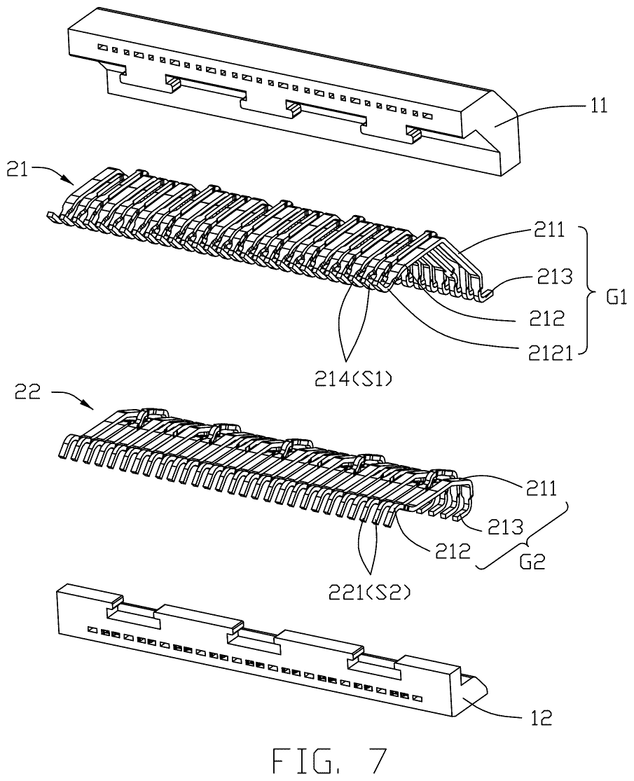

As shown in FIGS. 7-9, the first terminals 21 and the second terminals 22 each include a retaining portion 211 respectively fixed to the first insulator 11 and the second insulator 12, an elastic arm 212 exposed to the mating groove 133 by extending outwardly from the front end of the retaining portion 211, and a tail portion 213 extending from the rear end of the retaining portion 211. The elastic arm 212 is provided with a contacting portion 2121 protruding into the mating groove 133 for mating with a mating connector (not shown).

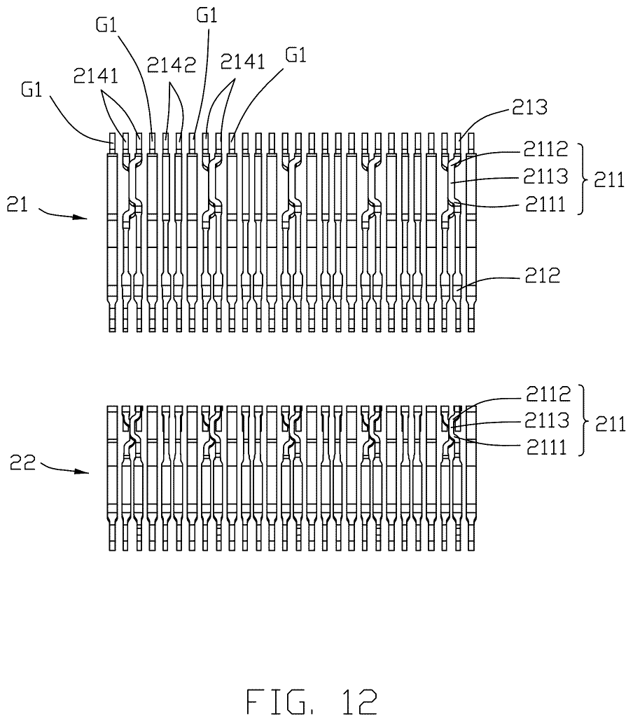

The first terminals 21 are arranged along the first direction and include a plurality of first differential-pair terminals 214 and first grounding terminals G1. The first differential-pair terminals 214 and the first grounding terminals G1 are arranged alternately with each other. Each first differential-pair terminals 214 include two first differential signal terminals S1. The first differential-pair terminals 214 is further classified into a first differential pair 2141 and a second differential pair 2142. The retaining portion 211 includes a first end close to the contacting portion 2121 and a second end close to the tail portion 213. The retaining portions 211 of the two first differential signal terminals S1 in the first differential pair 2141 have a first bending portion 2111 formed by bending toward each other from the first end, an overlapping portion 2113 formed by bending and extending from the first bending portion 2111 along a front-back direction perpendicular to the first direction, and a second bending portion 2112 formed by bending and extending from the overlapping portion 2113 along the first direction. The second bending portion 2112 is formed at the second end of the retaining portion. Bending toward each other means that one first differential signal terminal S1 in the same first differential-pair terminal 214 is bending in the direction close to the other first differential signal terminal S1. The retaining portions 211 of the two first differential signal terminals S1 in the second differential pair 2142 are arranged side by side in the first direction, and the retaining portions 211 of the two first differential signal terminals S1 have no overlapping portions in the second direction. Viewed from the second direction, the elastic arm 212 and the tail portion 213 of the same first differential signal terminal S1 and the first grounding terminal G1 are extending along the same straight line (shown in FIG. 12). The overlapping portion 2113 is formed as a signal improvement portion to reduce the signal crosstalk between the adjacent first differential pair 2141 and second differential pair 2142.

A row of the second terminals 22 is arranged along the first direction and includes a plurality of second differential-pair terminals 221 and a plurality of second grounding terminals G2. The second differential-pair terminal 221 and the second grounding terminals G2 are arranged alternately with each other. Like the first terminal 21, the second differential-pair terminal 221 includes two second differential signal terminals S2, and the second signal terminal pair 221 is further classified into the first differential pair 2141 having an overlapping portion 2113 overlapping each other in the second direction and the second differential pair 2142 having a retaining portion 211 arranged side by side in the first direction.

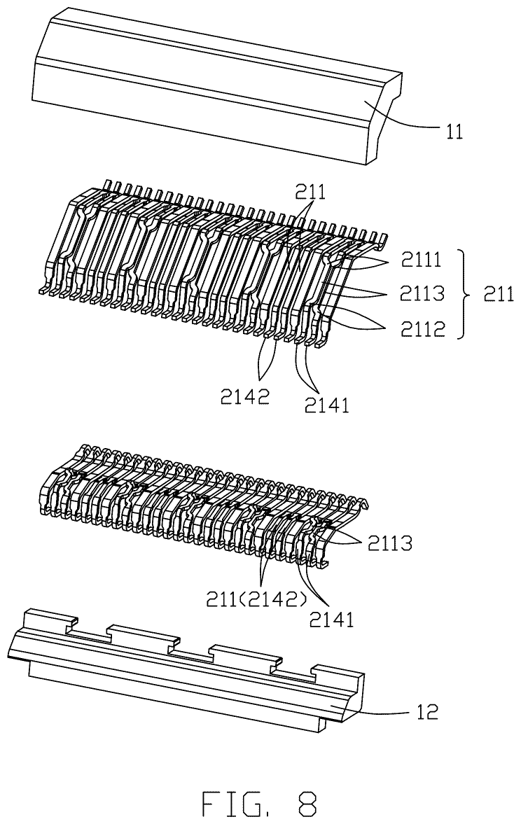

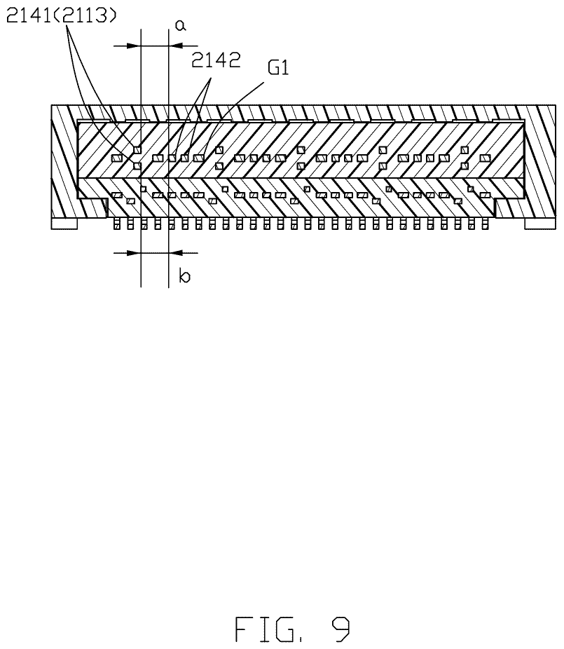

As shown in FIG. 8 and FIG. 9, the first differential pair 2141 and the second differential pair 2142 are arranged alternately with each other in the first direction to reduce signal crosstalk. Specifically, taking the first terminal 21 as an example, the first differential pair 2141 and the second differential pair 2142 are arranged alternately with the first grounding terminal G1 in the first direction, and the first grounding terminal G1 is arranged between the adjacent first differential pair 2141 and the second differential pair 2142. After excluding all the first grounding terminals G1, only for the first differential-pair terminals 214, a second differential pair 2142 is arranged between two adjacent first differential pairs 2141. Compared to the manner in which the first differential signal terminals S1 in all the first differential-pair terminals 214 are arranged side by side in the first direction, the retaining portions 211 of the two first differential signal terminals S1 in each first differential pair 2141 in the present invention protrude toward each other in the first direction to form an overlapping portion 2113.

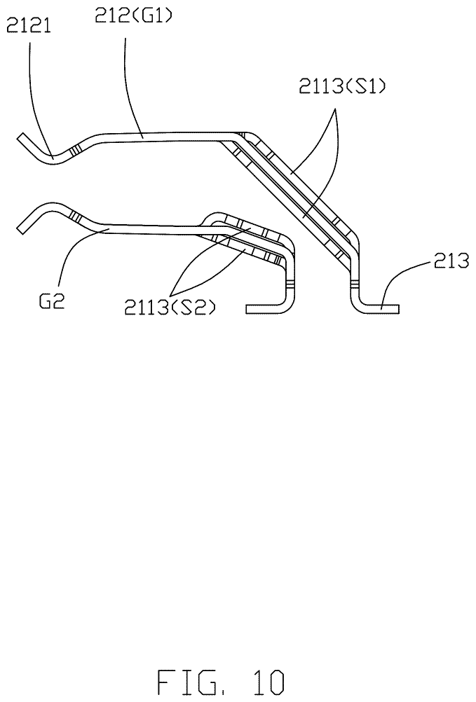

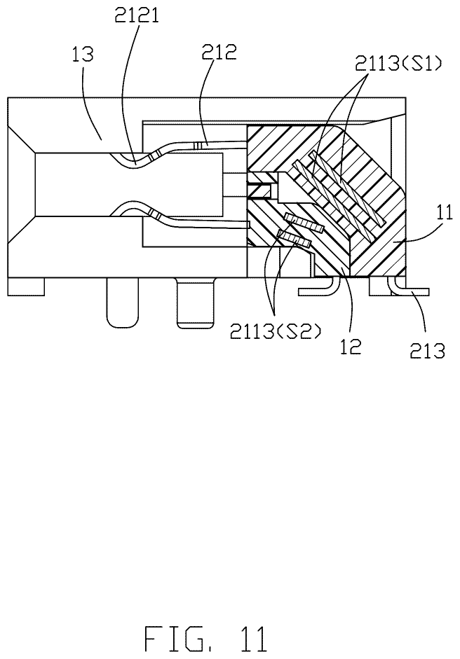

As shown in FIG. 10 and FIG. 11, viewing the first terminal 21 from the first direction, a plurality of the first grounding terminals G1 are arranged in the same plane. To achieve the overlapping arrangement of the retaining portions 211 of the two first differential signal terminals S1 in the first differential pair 2141 in the second direction, the overlapping portion 2113 in the retaining portion 211 is not only deviating relative to the contacting portion 2121 and the tail portion 213 in the first direction, but also the two first bending portions 2111 are bent upward and downward respectively in the second direction, so that the two overlapping portions 2113 are staggered in the second direction. The overlapping portions 2113 of the two first differential signal terminals S1 in the same first differential pair 2141 are respectively located on the upper and lower sides of the retaining portion 211 of the first differential signal terminal S1 in the second differential pair 2142 in the second direction. As shown in FIG. 9, the distance “a” from the retaining portion 211 of one of the first differential signal terminals S1 in the second differential pair 2142 to the overlapping portion 2113 located above in the first differential pair 2141 is equal to the distance “b” from the same retaining portion 211 to the overlapping portion 2113 located below. Also, in the second direction, the distance from the upper surface of the retaining portion 211 of the first differential signal terminal S1 in the second differential pair 2142 to the overlapping portion 2113 located above in the first differential pair 2141 is equal to the distance from the lower surface of the same retaining portion 211 to the overlapping portion 2113 located below in the first differential pair 2141, effectively reducing signal crosstalk between terminals.

The overlapping portions 2113 of the two first differential signal terminals S1 in the first differential pair 2141 are arranged at intervals in the second direction. Preferably, the distance between the lower surface of the overlapping portion 2113 of the first differential signal terminal S1 located above and the upper surface of the overlapping portion 2113 of the first differential signal terminal S1 located below is 1.5 times the thickness of the first differential signal terminal S1 in the second direction.

The contacting portions 2121 of the first differential signal terminals S1 and the first grounding terminals G1 are all arranged in a same plane in the first direction. The contacting portions 2121 of the second differential signal terminals S2 and the second grounding terminals G2 are all arranged in a same plane in the first direction. Therefore, when the electrical connector 100 is mated with a mating connector (not shown), the first terminals 21 and the second terminals 22 in the electrical connector 100 have the same plugging and unplugging force.

The first bending portion 2111, the second bending portion 2112 and the overlapping portion 2113 of the first terminal 21 and the second terminal 22 are integrally buried in the first insulator 11 and the second insulator 12, which is beneficial to adjusting the impedance of the terminals and realizing stable transmission of high-frequency signals. In other embodiments, the overlapping portion may also be disposed on the elastic arm and the tail portion.

Although the present invention has been described with reference to particular embodiments, it is not to be construed as being limited thereto. Various alterations and modifications can be made to the embodiments without in any way departing from the scope or spirit of the present invention as defined in the appended claims.

1. An electrical connector comprising:
an insulative housing; and
a row of first terminals arranged on the insulative housing along a first direction and each including a retaining portion fixed to the insulative housing, a contacting portion and a tail portion extending from two ends of the retaining portion respectively, the row of first terminals including a plurality of first differential-pair terminals and a plurality of first grounding terminals, the first differential-pair terminals and the first grounding terminals alternately arranged with each other along the first direction, each first differential-pair terminals including a pair of first differential signal terminals; wherein
the pair of first differential signal terminals of at least one of the plurality of first differential-pair terminals have overlapping portions overlapping each other in a second direction perpendicular to the first direction, and the contacting portion and the tail portion of each first differential signal terminals extend along a straight line as viewed from the second direction.

2. The electrical connector as claimed in claim 1, wherein the insulative housing is provided with a mating groove, each first terminal has an elastic arm extending from a front end of the retaining portion thereof, the elastic arm is provided with the contacting portion, and the contacting portion protrudes into the mating groove.

3. The electrical connector as claimed in claim 2, further comprising a row of second terminals, and wherein the row of first terminals is disposed at one side of the mating groove and the row of second terminals is disposed at the other side of the mating groove.

4. The electrical connector as claimed in claim 3, wherein the insulative housing includes a first insulator, a second insulator, and an insulative case, the row of first terminals is disposed in the first insulator, the row of second terminals is disposed in the second insulator, the mating groove is formed by a recessed front end of the insulative case, and the first insulator and the second insulator are assembled into the insulative case.

5. The electrical connector as claimed in claim 1, wherein a distance between the overlapping portions of the pair of first differential signal terminals in the second direction is 1.5 times the thickness of the first differential signal terminal in the second direction.

6. The electrical connector as claimed in claim 1, wherein viewed from the first direction the overlapping portions of the first differential signal terminals are respectively disposed on opposite sides of the retaining portions of the first grounding terminals, and the overlapping portions of the first differential-pair terminals are equidistant from the retaining portion of a corresponding first grounding terminal.

7. The electrical connector as claimed in claim 1, wherein viewed from the second direction the contacting portion, the retaining portion, and the tail portion of one first grounding terminal are disposed in a straight line, and the retaining portion of the first differential-pair terminal deviates from the contacting portion and the tail portion in the first direction to form the overlapping portion.

8. The electrical connector as claimed in claim 1, wherein the plurality of first differential-pair terminals include plural first differential pairs having retaining portions overlapping in the second direction and plural second differential pairs having retaining portions arranged side by side in the first direction, and the plural first differential pairs and the plural second differential pairs are alternately arranged in the first direction.

9. The electrical connector as claimed in claim 8, wherein each retaining portion in the first differential pair includes a first end close to the contacting portion and a second end close to the tail portion, and each retaining portion in the first differential pair includes a first bending portion deviating from the contacting portion in the first direction at the first end, an overlapping portion formed by bending and extending from the first bending portion along a front-back direction perpendicular to the first direction, and a second bending portion deviating from the overlapping portion in the first direction to be connected to the tail portion at the second end.

10. The electrical connector as claimed in claim 9, wherein the two first differential signal terminals of the first differential pair are equidistant from the differential signal terminals of an adjacent second differential pair in the first direction.

11. An electrical connector comprising:
an insulative housing; and
a row of first terminals arranged on the insulative housing along a first direction and each including a retaining portion fixed to the insulative housing, a contacting portion and a tail portion extending from two ends of the retaining portion respectively, the row of first terminals including a plurality of first differential-pair terminals and a plurality of first grounding terminals, the first differential-pair terminals and the first grounding terminals alternately arranged with each other along the first direction, each first differential-pair terminals including a pair of first differential signal terminals; wherein
the pair of first differential signal terminals of at least one of the plurality of first differential-pair terminals have a signal improvement portion, and the signal improvement portion has two opposite side surfaces exposed in the first direction relative to the grounding terminals, and the side surfaces of a pair of first differential signal terminals are equidistant from an adjacent first grounding terminal.

12. The electrical connector as claimed in claim 11, wherein the signal improvement portions of a pair of the first differential signal terminals in the first differential-pair terminal are arranged at intervals in a second direction, and the size of the interval between the two signal improvement portions in the second direction is 1.5 times the thickness of the first differential signal terminal in the second direction.

13. The electrical connector as claimed in claim 11, wherein viewed from the first direction, a plurality of the first grounding terminals are arranged in the same plane, the signal improvement portions of a pair of the first differential signal terminals respectively located on the upper and lower sides of the first grounding terminal in a second direction, and viewed from the second direction, the distances from two signal improvement portions of a pair of first differential signal terminals to an adjacent first grounding terminals are equal.

14. The electrical connector as claimed in claim 11, wherein viewed from a second direction perpendicular to the first direction, the contacting portion, the retaining portion and the tail portion of one first grounding terminal are all extending along the second direction and disposed on the same straight line, the contacting portion and the tail portion of one first differential signal terminal extending along the same straight line, the retaining portion of the first differential-pair terminal deviating from the contacting portion and the tail portion in the first direction to form the signal improvement portion.

15. The electrical connector as claimed in claim 14, the first differential-pair terminals include a first differential pair having the signal improvement portions and a second differential pair whose retaining portions are arranged side by side in the first direction, a plurality of the first differential pair and the second differential pair alternately arranged with the first ground terminal in the first direction.

16. The electrical connector as claimed in claim 14, wherein each retaining portions in the first differential pair include a first end close to the contacting portion and a second end close to the tail portion, each retaining portions in the first differential pair including a first bending portion deviating from the contacting portion in the first direction at the first end, a signal improvement portion formed by bending and extending from the first bending portion along a front-back direction perpendicular to the first direction, and a second bending portion deviating from the signal improvement portion in the first direction to be connected to the tail portion at the second end.

17. The electrical connector as claimed in claim 15, wherein in the adjacent first differential pair and second differential pair in the first direction, two first differential signal terminals in first differential pair are equidistant from any of the differential signal terminals in the second differential pair in the first direction.

18. An electrical connector comprising:
an insulative housing; and
a row of first terminals arranged on the insulative housing along a first direction and each including a retaining portion fixed to the insulative housing, a contacting portion and a tail portion extending from two ends of the retaining portion respectively, the row of first terminals including a plurality of first differential-pair terminals and a plurality of first grounding terminals, the first differential-pair terminals and the first grounding terminals alternately arranged with each other along the first direction, each first differential-pair terminals including a pair of first differential signal terminals; wherein
the pair of first differential signal terminals of at least one of the plurality of first differential-pair terminals have a signal improvement portion, the signal improvement portion has side surfaces exposed in the first direction relative to the grounding terminals, and the side surfaces of a pair of first differential signal terminals extend in a second direction perpendicular to the first direction and are arranged in a same plane.

19. The electrical connector as claimed in claim 18, wherein the signal improvement portions of a pair of the first differential signal terminals in the first differential-pair terminal are arranged at intervals in a second direction, and the size of the interval between the two signal improvement portions in the second direction is 1.5 times the thickness of the first differential signal terminal in the second direction.

20. The electrical connector as claimed in claim 18, wherein the retaining portion deviates from the contacting portion and the tail portion in the first direction to form the signal improvement portion, and the first differential-pair terminals include a first differential pair having the signal improvement portions and a second differential pair whose retaining portions are arranged side by side in the first direction, a plurality of the first differential pair and the second differential pair alternately arranged with the first ground terminal in the first direction.
